(19) United States
(12) Patent Application Publication
(10) Pub. No.: US 2025/0292955 A1
(43) Pub. Date: Sep. 18, 2025

(54) BOBBIN AND MAGNETIC COMPONENT

(71) Applicant: Delta Electronics (Thailand) Public Co., Ltd., Samutprakarn (TH)

(72) Inventors: Shangeeth Kumar SHANMUGHAM, Soest (DE); Hugues NJIENDE, Soest (DE)

(21) Appl. No.: 19/044,577

(22) Filed: Feb. 3, 2025

(30) Foreign Application Priority Data
Mar. 15, 2024 (EP) 24163896.4

(51) Int. Cl. H01F 27/32; H01F 27/30

(52) U.S. Cl. CPC H01F 27/325; H01F 27/306

(57) ABSTRACT

The disclosure concerns a bobbin for holding insulated winding, comprising a base body with an outer surface around which the winding is wound so as to define a winding axis; wherein the outer surface comprises at least one threaded portion which spirals along a longitudinal axis of the base body, the threaded portion defining thread projections and a thread root; the winding comprises multiple radial winding layers stacked along a radial direction substantially perpendicular to the winding axis, and at least one radial winding layer is inserted into the at least one threaded portion. The disclosure also concerns a magnetic component comprising the bobbin.

### CROSS-REFERENCE TO RELATED APPLICATION

This application claims priority to European Patent Application No. 24163896.4, filed on Mar. 15, 2024, which is hereby incorporated by reference in its entirety.

### TECHNICAL FIELD

The disclosure concerns a bobbin for holding insulated winding. Furthermore, the disclosure concerns a magnetic component comprising at least one such bobbin.

### BACKGROUND

Conventionally, bobbins for holding electrical winding, for instance in a transformer, are known.

For example, from JP H07-130562 A, a bobbin structure is known for a flyback transformer. Therein, a low voltage bobbin comprises helical grooves for the purpose of providing winding therein. Therein, the winding itself is a litz wire and is not insulated. Therefore, the helical groove thereof provides insulation between two winding layers adjacent to one another along a winding axis. Furthermore, the flyback transformer of said known technology comprises a low-pressure bobbin and a high-pressure bobbin. Therein, input primary windings are wound on the low-pressure bobbin, and high pressure secondary output windings are wound on the high pressure bobbin outside of the low-pressure bobbin. In other words, said flyback transformer comprises a low-pressure bobbin for the primary winding, and a high-pressure bobbin for the secondary winding. These bobbins are separated and insulated from one another via epoxy resin.

The flyback transformer of JP H07-130562 A has several drawbacks. For one, the bobbins are configured such that multiple bobbins are necessary for forming primary and secondary windings of the transformer. Furthermore, due to lack of wire insulation and due to the configuration of the helical groove therein, the litz wire thereof cannot be radially stacked. In particular, no one portion of the winding therein may be in contact with another portion of the same winding therein without affecting a number of turns and electrical diameter of the winding thereof due to shorting of the windings. Thus, radially stacking different winding portions, for example primary and secondary windings, therein is not possible. Furthermore, especially due to the necessity of multiple bobbins for providing primary and secondary winding therein, the flyback transformer of JP H07-130562 A is highly space-consuming and inefficient with respect to its cooling properties.

JP 7168902 B2 discloses a bobbin and coil device. The bobbin comprises a plurality of winding partition flanges which separate wire winding portions adjacent to each other along a winding axis of a wire for each winding section. The winding partition flanges are formed on an outer peripheral portion of the bobbin. The adjacent winding sections formed in each of the winding partition flanges are connected via communication grooves.

The bobbin and coil device known therefrom are disadvantageous with regard to manufacturing ease and efficiency, especially when considering automated winding processes, and also cannot provide suitable stacking of multiple radial layers of winding.

From CN 217484289 U, a rotary transformer winding tool is known. Therein, coils are wound on the rotary transformer. However, said rotary transformer winding tool also has the foregoing described disadvantages, in particular lack of ease of manufacturing and winding, low cooling efficiency, and high space requirements.

### SUMMARY

It is an object of the present disclosure to overcome these deficiencies. In particular, it is an object of the present disclosure to provide a bobbin for holding insulated winding with a compact size, which can be cooled with high efficiency, and which allows for easy and efficient manufacturing, especially with regard to a winding process. Furthermore, it is an object of the present disclosure to provide a magnetic component with these advantages. The solution of these objects is achieved by the subject matter of the independent claim. The dependent claims contain advantageous embodiments of the present disclosure.

In particular, the solution of these objects is achieved by the bobbin according to claim 1. Therein, the bobbin of the present disclosure is configured to hold insulated winding. The bobbin comprises a base body with an outer surface around which the winding is wound so as to define a winding axis. Therein, the outer surface comprises at least one threaded portion which spirals along a longitudinal axis of the base body, the threaded portion defining one or more thread projections and one or more thread roots. The winding of the bobbin comprises multiple radial winding layers stacked along a radial direction substantially perpendicular to the winding axis. Furthermore, at least one radial winding layer is inserted into the at least one threaded portion.

Due to the at least one threaded portion of the bobbin, the ease of manufacturing thereof, especially a step of winding especially using an automated winding device, is provided. Furthermore, by providing multiple radial winding layers, larger portions of winding can be cooled in common, thereby increasing the cooling efficiency thereof. Further yet, due to the winding being an insulated winding, the radial winding layers may comprises different potentials, and may for example be a part of a primary winding and a secondary winding (with respect to different radial winding layers).

In the foregoing and in the following, the following directions and axes are defined. In a finished or manufactured state, the winding surrounds the outer surface of the base body of the bobbin and thereby defines a winding axis that is an axis around which the winding is wound. In particular, the winding axis extends along the longitudinal axis of the base body. In some embodiments, the winding axis and the longitudinal axis of the base body are parallel to one another. Furthermore, the radial direction is substantially perpendicular to the winding axis. In the foregoing and in the following, the radial direction extends from the winding axis towards the outer surface of the base body. In other words, the positive radial direction is defined as extending from the winding axis to the outer surface, whereas a negative radial direction is defined as extending from the outer surface towards the winding axis.

Furthermore, in the foregoing and in the following, the terms “thread projections” and “thread roots” are used. The thread projections herein refer to the projections of a thread (for example considering a screw thread) which define a pitch of the thread. Furthermore, the thread root refers to the portions of the thread between adjacent projections. Furthermore, in the foregoing and in the following, the threaded portion is described as spiralling along a longitudinal axis of the base body. In some embodiments, this term refers to a helix shape with a helix axis along or parallel to the longitudinal axis of the base body. Further yet, the term “following the spiral extension” or similar terms refer to viewing especially the threaded portion along the longitudinal axis and along a circumferential direction of the base body.

In this regard, although a single threaded portion principally may be defined as comprising or consisting of exactly one thread projection and exactly one thread root (the thread root being defined by the pitch of the thread projection) together spiraling in a helical shape, in the foregoing and in the following, multiple thread projections and thread roots are referred to as adjacent elements of the threaded portion when following the longitudinal axis of the base body.

In some embodiments, the thread root corresponds to portions of the outer surface of the base body between the thread projections. In particular, the thread root is flush with (other portions of) the outer surface. In some embodiments, the thread root is not flush with the outer surface. For example, portions of the base body corresponding to the thread root are thicker or wider than portions of the base body outside of the at least one threaded portion. In other words, the at least one threaded portion is raised radially with respect to non-threaded portions of the base body. In some embodiments, each threaded portion is raised by the same amount or one or more, especially each, threaded portion is raised by a different amount. Thereby, different portions of the bobbin for example corresponding to different types or usages of winding may be different (radial and/or longitudinal) sizes, thereby allowing a high flexibility of usage and increased cooling efficiency.

In some embodiments, exactly one longitudinal layer of the winding is inserted between two thread projections of the threaded portion. In other words, the threaded portions separate two adjacent longitudinal layers of the winding along the longitudinal axis of the base body from one another.

In some embodiments, a thread pitch of the threaded portion is equal to or greater than a cross-sectional diameter of the winding and less than twice the cross-sectional diameter of the winding. In some embodiments, the tread pitch of the threaded portion is such that no more than one longitudinal layer of the winding is insertable between two thread projections. In particular, in some embodiments no more than one full longitudinal layer of the winding is insertable between two thread projections. In other words, for example, the thread pitch of the threaded portion may for example be equal to one and a half times the cross-sectional diameter of the winding, such that exactly one longitudinal layer of the winding is insertable between two thread projections with a tolerance of half of the cross-sectional diameter of the winding, wherein however no further longitudinal layer of winding is provided in between the aforementioned two projections.

In some embodiments, the outer surface comprises exactly one continuous threaded portion. In this regard, one continuous threaded portion is defined by continuous thread roots between continuous thread projections. On the other hand, non-continuous or interrupted thread projections are, in the foregoing and in the following, referred to as different threaded portions.

In some embodiments, the thread root of the threaded portion is substantially flat or concave. Thereby, ease of manufacturing and cooling efficiency of the bobbin are advantageously increased, while damages to the winding, especially insulation of the winding, are advantageously prevented.

In some embodiments, the base body comprises at least one flange at respectively one end along its longitudinal axis. In further embodiments, the base body comprises one flange at each end along its longitudinal axis, i.e. comprises two flanges. Thereby, slippage of the winding from the bobbin is advantageously prevented, and ease of manufacturing thus increased.

In some embodiments, the outer surface of the base body comprises at least one non-threaded portion at respectively one end, along the longitudinal axis, of the threaded portion. Thereby, for example, the bobbin is advantageously provided with a transition portion as the at least one non-threaded portion. This increases ease and efficiency of manufacturing, especially with respect to the winding process. In particular, in some cases in which the base body comprises at least one flange and at least one non-threaded portion at the flange, the non-threaded portion advantageously prevents positioning errors when the winding is wound around the base body.

In an advantageous embodiment in which the base body comprises at least one flange and at least one non-threaded portion at respectively one end, i.e. at the flange, at least two longitudinal layers of the winding are inserted into one non-threaded portion. Therein, the at least two longitudinal layers are in contact with one another. In some embodiments, more than two longitudinal layers are inserted into one non-threaded portion. For example, three or more or four or more or five or more longitudinal layers are inserted into one non-threaded portion.

Further in some embodiments, the bobbin comprises multiple, especially two, such non-threaded portions, especially at respectively one end along the longitudinal axis, of the threaded portion. In other words, the bobbin according to some embodiments comprises two non-threaded portions and one threaded portion, the threaded portion being disposed between the non-threaded portions along the longitudinal axis. In some embodiments, therein, flanges are respectively disposed at the ends of each of the two non-threaded portions. Thereby, ease and efficiency of manufacturing is advantageously increased.

In further embodiments, at least one radial winding layer is stacked radially on at least one thread projection of the threaded portion. Thereby, an advantageously compact and space-saving positioning of winding layers is achieved, thereby also increasing cooling efficiency thereof.

In some embodiments, a thread pitch of the threaded portion is substantially constant along the longitudinal axis of the base body. In other words, the distance between two adjacent thread projections is substantially constant when following the spiral shape thereof along the longitudinal axis of the base body. In this regard, “substantially constant” refers to the thread pitch being constant within manufacturing tolerances of for example ±10%. The substantially constant thread pitch of the threaded portion has the advantage in that the winding process is simplified, thereby providing ease and efficiency of manufacturing.

In some embodiments, a cross-sectional shape plane-parallel to the longitudinal axis of the thread projections is substantially constant along the spiraling extension of the threaded portion. In other words, in some embodiments, the cross-sectional shape of the thread projections is substantially constant along the longitudinal axis and along the circumferential direction of the base body, i.e. when following the spiral extension of the threaded portion. Thereby, the manufacturing process for manufacturing the bobbin, in particular the base body including the threaded portion of the bobbin, is simplified.

In some embodiments, the cross-sectional shape plane-parallel to the longitudinal axis of the thread projections varies along the spiraling extension of the threaded portion. In other words, said cross-sectional shape of the thread projections is not constant along the spiraling extension of the threaded portion. Thereby, geometries of threaded portions which increase ease of manufacturing, especially with respect to the winding process, and/or reduce slippage of the winding are advantageously possible. Furthermore, the varying cross-sectional shape of the thread projections advantageously provides guidance for portions of the base body at which more or less sections of winding are to be provided, thereby increasing ease of manufacturing.

In some embodiments, said cross-sectional shape of the thread projections is tapered towards at least one end of the thread projections along the spiraling extension of the threaded portion. In other words, along the longitudinal axis, when following the spiraling extension of the threaded portion, the cross-sectional shape thereof is tapered towards at least one of the ends of the thread projections. In some embodiments, said cross-sectional shape of the thread projections is tapered towards both ends of the thread projections. Thereby, the tapered end(s) of the threaded portion(s) advantageously provides a transition between non-threaded portions and threaded portions of the base body. Thereby, misalignment or positioning issues during the winding process are advantageously prevented or reduced. Furthermore, such tapered ends of the threaded portion(s) advantageously prevent damages to the windings by reducing a number of sharp edges of the threaded portion(s).

In some embodiments, the winding comprises a first winding portion and a second winding portion which are electrically insulated from one another. In other words, in some embodiments, the first winding portion and the second winding portion are not directly electrically connected to one another. Herein, one (first) winding portion inducing a current in another (second) winding portion, for example in the exemplary case of a transformer, falls under the definition of “electrically insulated from one another”.

In the foregoing embodiment, only the radial winding layer(s) of the first winding portion of the winding is/are inserted into the threaded portion. In other words, the winding of the second winding portion or of other winding portions with the exception of the first winding portion are not inserted into the threaded portion. In some embodiments in which the bobbin comprises multiple threaded portions, each such threaded portion only has the winding of one foregoing described winding portion inserted therein. For example, a first threaded portion comprises only the winding of the first winding portion, and a second threaded portion comprises only the winding of a second winding portion.

In some embodiments, only the radial winding layer(s) of the second winding portion of the winding is/are stacked radially on at least one thread projection of the threaded portion. For example, the winding of the first winding portion is inserted into the threaded portion. The winding of the second winding portion is stacked radially on the at least one thread projection of the threaded portion. In some embodiments, therein, the winding of the second winding portion is not stacked radially on the winding of the first winding portion. In some embodiments, therein, further radial winding layers of the first winding portion are stacked radially on the winding of the first winding portion that is inserted into the threaded portion.

Further advantageously, the first winding portion and the second winding portion are at least partially in a bifilar arrangement. Thereby, ease and efficiency of manufacturing, especially concerning the winding process, is advantageously achieved.

In some embodiments, in the bifilar arrangement, in the first radial winding layer, the first winding portion is inserted into the threaded portion, and in at least one further radial winding layer, the first winding portion and the second winding portion are arranged in bifilar arrangement such that the second winding portion is stacked radially on the thread projections and such that the first winding portion is stacked radially on the first winding portion of the first radial winding layer. In some embodiments, the thread pitch of the threaded portion as well as the dimensions of the thread projections and thread root corresponds to the cross-sectional diameters of the winding of the first winding portion and the second winding portion. In some embodiments, a cross-sectional width plane parallel to the longitudinal axis of the thread projections is substantially equal to the cross-sectional diameter of the winding of the first winding portion and/or of the second winding portion, especially substantially equal to the cross-sectional diameter of all winding portions of the winding. Thereby, ease and efficiency of manufacturing as well as advantageous cooling efficiency are achieved.

In some embodiments, the bobbin comprises multiple base bodies. In some embodiments, the multiple base bodies are formed integrally with one another. Further, each of the plurality of base bodies comprises a separate winding. In some embodiments, the winding wound around one base body is in series with the winding around another base body of the same bobbin, in series with only one or more winding portion(s) thereof.

The present disclosure further concerns a magnetic component. The magnetic component comprises at least one bobbin according to any one of the foregoing described embodiments and examples.

In some embodiments, the magnetic component comprises a transformer and/or a choke. In the example of the magnetic component comprising a transformer, the first winding portion is part of a primary winding and the second winding portion is part of a secondary winding of the transformer. Thereby, a magnetic component, especially a transformer, is achieved with a compact and space-saving shape and with high cooling efficiency, which can also be easily and efficiently manufactured, especially with regard to the winding processes.

In some embodiments, the magnetic component comprises multiple bobbins, each forming a part of a phase of a multi-phase transformer. For example, the magnetic component comprises a three-phase transformer and correspondingly three bobbins, each forming a part of one phase of the transformer. Further bobbins may form a part of one or more chokes.

The foregoing described embodiments and configurations may be combined.

### BRIEF DESCRIPTION OF DRAWINGS

Further details, advantages, and features of the preferred embodiments of the present disclosure are described in detail with reference to the figures. Therein:

FIG. 1 shows a schematic side view of a bobbin according to a first embodiment of the present disclosure;

FIG. 2 shows a perspective view of the bobbin according to the first embodiment of the present disclosure;

FIG. 3 shows a cross-sectional view of the bobbin according to the first embodiment of the present disclosure;

FIG. 4 shows a schematic side view of a bobbin according to a second embodiment of the present disclosure;

FIG. 5 shows a perspective view of the bobbin according to the second embodiment of the present disclosure;

FIG. 6 shows a cross-sectional view of the bobbin according to the second embodiment of the present disclosure;

FIG. 7 shows a schematic side view of a bobbin according to a third embodiment of the present disclosure;

FIG. 8 shows a perspective view of the bobbin according to the third embodiment of the present disclosure;

FIG. 9 shows a cross-sectional view of the bobbin according to the third embodiment of the present disclosure;

FIG. 10 shows a perspective view of a bobbin according to a fourth embodiment of the present disclosure; and

FIG. 11 shows a schematic view of a magnetic component according to a fifth embodiment of the present disclosure.

### DESCRIPTION OF EMBODIMENTS

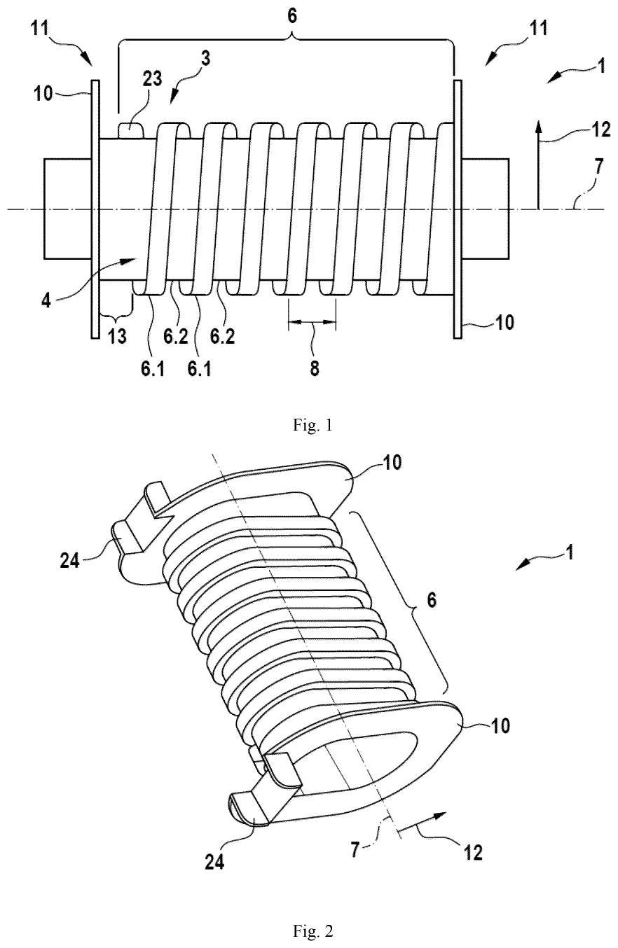

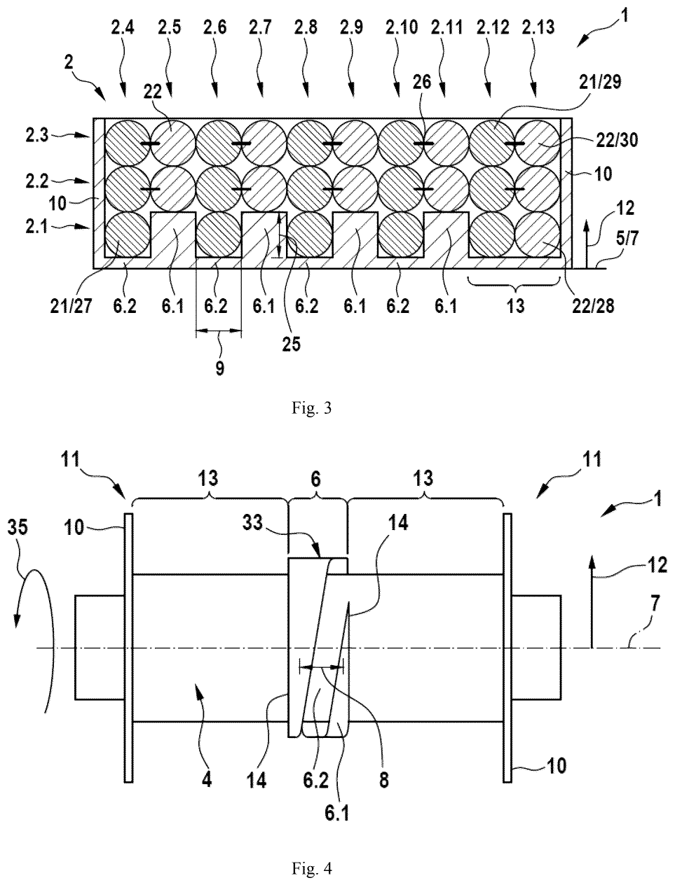

A first embodiment of the present disclosure will be described with reference to FIGS. 1-3. Therein, FIG. 1 shows a schematic side view of a bobbin 1 according to a first embodiment of the present disclosure, FIG. 2 shows a perspective view of the bobbin 1 according to the first embodiment of the present disclosure, and FIG. 3 shows a cross-sectional view of the bobbin 1 according to the first embodiment of the present disclosure.

In particular, an insulated winding 2 of the bobbin 1 of the present embodiment, which will be discussed especially with respect to FIG. 3, is omitted in FIGS. 1 & 2 for ease of explanation of the bobbin 1. In other words, FIGS. 1 & 2 particularly show a state of the bobbin 1 before the winding 2 is wound, whereas FIG. 3 shows a state of the bobbin 1 after the winding 2 has been wound. Furthermore, FIG. 3 shows one radial half of the bobbin 1 for the ease of explanation.

The bobbin 1 comprises a base body 3 and the insulated winding 2. The base body 3 comprises an outer surface 4 around which the winding 2 is (to be) wound (see FIG. 3).

The outer surface 4 comprises, in the present embodiment, one threaded portion 6. The threaded portion 6, as shown in FIGS. 1 and 2, spirals along a longitudinal axis 7 of the base body 3. The threaded portion 6 defines thread projections 6.1 and a thread root 6.2.

The thread projections 6.1 project, along a radial direction 12, from the outer surface 4. The thread root 6.2 corresponds to the outer surface 4 of the base body 3 between the thread projections 6.1. In other words, as can be seen in FIGS. 1 and 2, the thread root 6.2 is flush with the outer surface 4 at non-threaded portions 13.

The thread root 6.2 of the present embodiment is flat. In alternative embodiments, the thread root 6.2 is concave in the radial direction 12, thereby allowing a tighter fit of the winding 2. The concave or flat configuration of the thread root 6.2 allows a tight fit of the winding 2 while preventing damages, for example damage to an insulation, thereto during a winding process.

A thread pitch 8, which is defined as a distance between two thread projections 6.1 along the longitudinal axis 7, of the threaded portion 6 in the present embodiment is substantially constant along the longitudinal axis 7.

Furthermore, a cross-sectional shape plane-parallel to the longitudinal axis 7 of the thread projections 6.1 is in this example substantially constant along the spiraling extension of the threaded portion 6. Herein, the cross-sectional shape plane refers to a plane for example defined by the extensions of the longitudinal axis 7 and the radial direction 12. In FIG. 1, a top-left end 23 of the threaded portion 6 shows said cross-sectional shape, which is herein rectangular.

The base body 3 in the present embodiment comprises two flanges 10, each at respectively one end 11 of the base body along its longitudinal axis 7.

As shown in FIG. 2, each of the two flanges 10 comprises a winding guide portion 24 for guiding the winding 2 to/from the bobbin 1.

Now, with reference to FIG. 3, the insulated winding 2 of the bobbin 1 of the present embodiment will be explained. In some embodiments, the insulated winding 2 is wound around the bobbin 1 using a winding process such as automated winding. The winding 2 defines a winding axis 5 around which it is wound. In the present embodiment, the winding axis 5 is parallel to the longitudinal axis 7. In particular, the winding axis 5 and the longitudinal axis 7 are, in the present embodiment, co-axial.

The winding 2 comprises multiple, in this example exactly three, radial winding layers 2.1-2.3. The radial winding layers 2.1-2.3 are stacked along the radial direction 12. In the present embodiment, the radial winding layers 2.1-2.3 are stacked perpendicular to the winding axis 5.

Furthermore, one radial winding layer 2.1 is inserted into the threaded portion 6. In particular, only one radial winding layer 2.1 is inserted into the threaded portion 6.

Further, the winding 2 comprises multiple, in this example exactly ten, longitudinal layers 2.4-2.13.

The thread pitch 8 of the threaded portion 6 is equal to or greater than a cross-sectional diameter 9 (corresponding to aforementioned cross-sectional shape) of the winding 2 and less than twice the cross-sectional diameter 9 of the winding 2. In other words, only one longitudinal layer 2.4-2.13 is inserted between two thread projections 6.1 of the threaded portion 6. In this regard, it is noted that the thread pitch 8 comprises—per definition—two halves of the corresponding thread projections 6.1 between which the thread pitch 8 is defined.

In a definition of the foregoing, a distance between two thread projections 6.1, in other words a width of the thread root 6.2 along the longitudinal axis 7, is roughly equal to the cross-sectional diameter 9 of the winding 2.

Furthermore, only one longitudinal layer 2.4 and only radial winding layer 2.1 is inserted between two thread projections 6.1 of the threaded portion 6. In other words, a cross-sectional height 25 of the thread projections 6.1 in radial direction 12 is roughly equal to the cross-sectional diameter 9 of the winding 2.

As shown in FIGS. 1 and 3 and discussed above, the base body 3 comprises the flange 10 and at least one non-threaded portion 13 at respectively one end 11, i.e. at the flange 10. Therein, at least two longitudinal layers 2.12, 2.13 of the winding 2 are inserted into the one non-threaded portion 13 between the flange 10 and a first thread projection 6.1 of the threaded portion 6. Therein, said two longitudinal layers 2.12, 2.13 are in contact with one another. This will now be explained in more detail. At the respective other end 11, one longitudinal layer 2.4 is provided between the flange 10 and the (last or fourth) thread projection 6.1.

As indicated in FIG. 3 via different hatching, in the present embodiment, the winding 2 comprises a first winding portion 21 and a second winding portion 22 which are electrically insulated from one another. In other words, the first winding portion 21 and the second winding portion 22 are not directly electrically connected to one another. As will be explained with reference to FIG. 11, the first winding portion 21 and the second winding portion 22 can be, for example, primary winding and secondary winding or for example a choke winding and a primary or secondary winding, etc.

Herein, shown imaginary lines 26 indicate that the first winding portion 21 and the second winding portion 22 are in a bifilar arrangement, i.e. are wound around the base body 3 together. This is, however, not necessarily the case, and the first winding portion 21 and the second winding portion 22 may be wound separately around the base body 3.

Further herein, only the radial winding layers 2.1-2.3 of the first winding portion 21 are inserted between the thread projections 6.1. In particular, only one radial winding layer 2.1 and only one longitudinal layer 2.6, 2.8, and 2.10 of the first winding portion 21 are inserted in between the thread projections 6.1 on the thread root 6.2.

Only the radial winding layers 2.2 and 2.3 of the second winding portion 22 are stacked radially on the thread projections 6.1 of the threaded portion 6. On the other hand, only the radial winding layers 2.2 and 2.3 of the first winding portion 21 are stacked radially on the first radial winding layer 2.1 of the first winding portion 21. In the non-threaded portion 13, the radial winding layers 2.1, 2.2, and 2.3, especially all of them, of the first winding portion 21 and of the second winding portion 22 are stacked on the outer surface 4 of the base body 3.

It should be noted that the total number of radial winding layers 2.1-2.3 and/or the total number of longitudinal winding layers 2.4-2.13 is not generally restricted to what is described in the embodiments. In particular, it should be noted that the number of winding layers and especially their total number of turns is adaptable, especially for specific applications of the bobbin 1.

Now, a winding process will be described with respect to the first and second winding portions 21, 22 and their bifilar arrangement.

In FIG. 3, a beginning of the first winding portion 21 is denoted with reference numeral 27. Furthermore, a beginning of the second winding portion 22 is denoted with reference numeral 28. An end of the first winding portion 21 is denoted with reference numeral 29, and an end of the second winding portion 22 is denoted with reference numeral 30.

As implied thereby, the winding process starts (on the left of FIG. 3) first with providing the first winding portion 21 in the threaded portion 6. At the end of a first (along longitudinal axis 7) passage, denoted by the beginning 28 of the second winding portion 22, the first winding portion 21 and the second winding portion 22 are then starting with a second passage wound in bifilar arrangement. Each radial winding layer 2.1-2.3 is thus formed by winding the winding portions 21, 22 once following along the longitudinal axis 7. In other words, the winding process starts on the left of FIG. 3, proceeds to the right for the first radial winding layer 2.1, then back to the left (on the top of the threaded portion 6) for the second radial winding layer 2.2, and then back to the right (on the top of the second radial winding layer 2.2) for the third and final radial winding layer 2.3. In this example, the number of turns of the first winding portion 21 is consequently greater than the number of turns of the second winding portion 22.

By providing this arrangement, the following exemplary advantages are achieved. Firstly, by stacking the winding 2 radially as shown, especially the second winding portion 22 on the thread projections 6.1, a substantial reduction of air-filled space is achieved as opposed to a case in which the threaded portion 6 is not provided, i.e. as opposed to a case in which the outer surface 4 of the bobbin 1 is flat in cross-section. This greatly enhances the cooling efficiency when cooling the winding 2. Furthermore, this bobbin 1 provides an efficient winding process, since for example the number of turns of respective winding portions 21, 22 is easily pre-determined, especially via the thread pitch 8 and/or number of and/or length of threaded portions 6.

It should be noted, however, that the herein described winding process and result shown in FIG. 3 is an optimal case. In real-world applications, some of the upper radial windings layers 2.2-2.3 may slip such that parts of the second winding portion 22 are arranged (at least partially) on parts of the primary winding portion 21 and vice-versa, or parts of the primary winding portion 21 are arranged (at least partially) on the projections 6.1. On the other hand, due to the advantageous configuration of the threaded portion 6, the likelihood of such cases is decreased. Furthermore, even in such cases, due to the threaded portion 6, the first winding portion 21 is securely held between the thread projections 6.1.

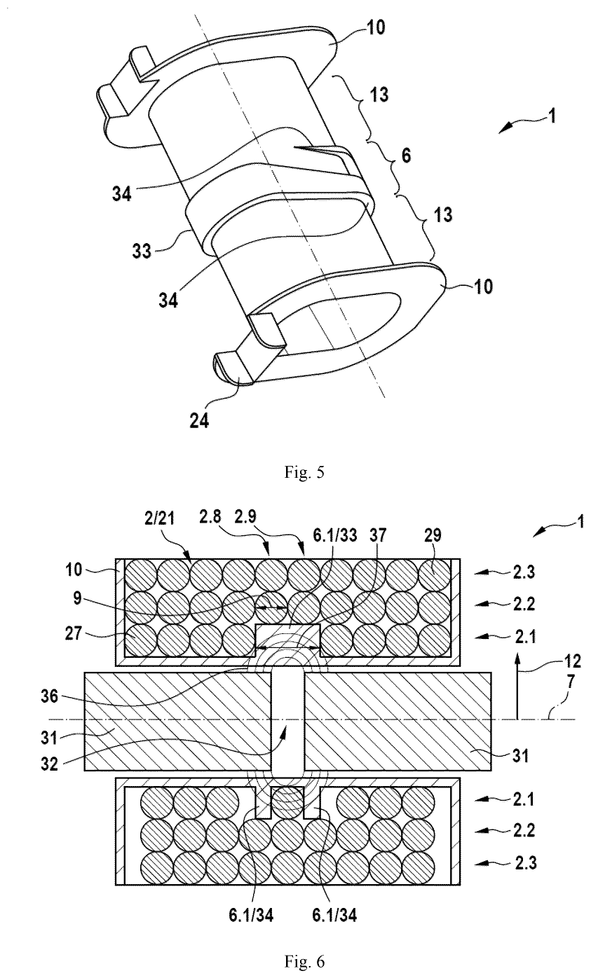

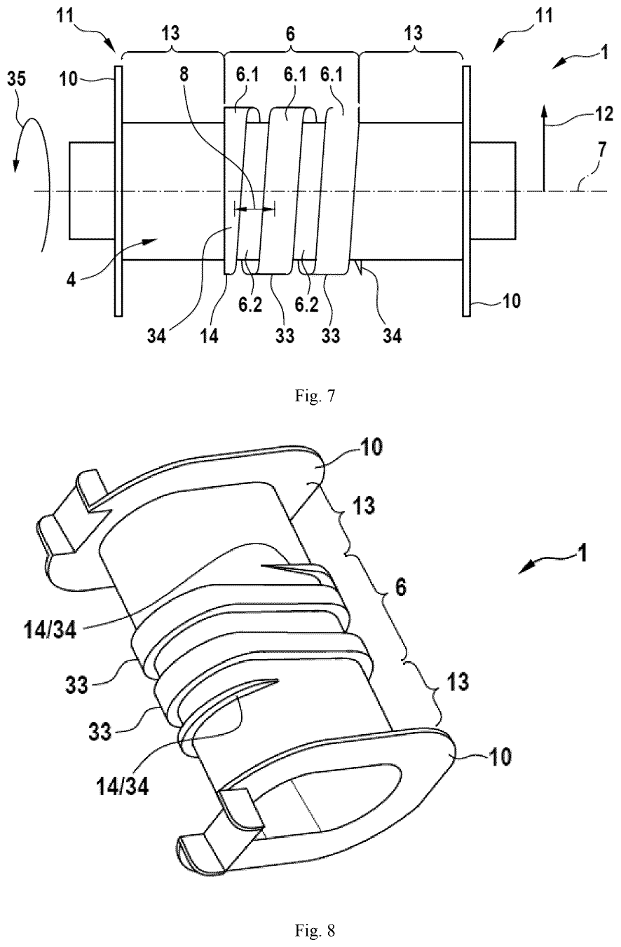

Now, with reference to FIGS. 4-6, a second embodiment of the present disclosure will be explained. Therein, FIG. 4 shows a schematic side view of a bobbin 1 according to the second embodiment of the present disclosure, FIG. 5 shows a perspective view of the bobbin 1 according to the second embodiment of the present disclosure, and FIG. 6 shows a cross-sectional view of the bobbin 1 according to the second embodiment of the present disclosure.

As in FIGS. 1-3, FIGS. 4 and 5 of the present embodiment omit the winding 2 for ease of explanation, whereas FIG. 6 shows the wound state of the bobbin 1. Herein, FIG. 6 shows both radial halves (i.e. full cross-sectional view) of the bobbin 1. Furthermore, FIG. 6 shows exemplary two magnetic cores 31 inserted into the bobbin 1.

The bobbin 1 of the present embodiment comprises two non-threaded portions 13, each at respectively one end 11 of the base body 3 along the longitudinal axis 7.

Between the two non-threaded portions 13, the bobbin 1 comprises one threaded portion 6. Herein, the threaded portion 6 comprises a single thread, i.e. two thread projections 6.1 and one thread root 6.2. Along the longitudinal axis 7, the threaded portion 6 and the two non-threaded portions 13 each comprise roughly one-third of a length of the base body 3.

Herein, said cross-sectional shape plane-parallel to the longitudinal axis 7, for instance in the plane of the radial direction 12 and the longitudinal axis 7, of the thread projections 6.1 varies along the spiraling extension of the threaded portion 6. In particular, said cross-sectional shape varies gradually and continuously along the spiraling extension of the threaded portion 6.

In particular, said cross-sectional shape of the thread projections 6.1 is tapered towards ends 14 of the thread projections 6.1. Thereby, damages to the winding 2, especially to the insulation thereof, can be prevented or reduced during the winding process.

Now, with reference to FIG. 6, the winding 2 of the bobbin 1 of the present embodiment is described.

Due to the tapered thread projections 6.1, as shown in FIG. 6, the threaded portion 6 of the present embodiment comprises, continuously along a circumferential direction 35, which is perpendicular to the radial direction 12 and to the longitudinal axis 7, of the base body 3, one thick thread projection 33 and two thin thread projections 34.

In the present embodiment, the two thin thread projections 34 are defined as parts of the threaded portion 6 along the circumferential direction 35, in which the cross-sectional width 37 of the thread projections 6.1 is less than the cross-sectional width 9 of the winding 2. The other parts of the threaded portion 6 along the circumferential direction 35, in which the cross-sectional width 37 is equal to or greater than the cross-sectional width 9 of the winding 2 is defined as the thick thread projection 33.

Herein, a thread pitch 8, defined by a distance between middle points of the thread projections 6.1 along the longitudinal axis 7, is constant where two adjacent thread projections 6.1 are present. In other words, a width of the thread root 6.2 along the longitudinal axis 7 is constant along its spiraling extension.

Herein, for example, only one winding portion 21 is provided. However, the present embodiment can be suitably combined with the foregoing embodiment such that two winding portions 21, 22 are provided.

In the present embodiment, only one radial winding layer 2.1 of the winding 2 is inserted into the threaded portion 6 between the two thread projections 6.1, i.e. between the two thin thread projections 34. As stated above, the cross-sectional shape of the thread projections 6.1 varies along the spiraling extension of the threaded portion 6. Herein, a maximal cross-sectional width 37 of the thread projection 6.1, i.e. the thick thread projection 33, is equal to or greater than the cross-sectional width 9 of the winding 2, and is for example roughly twice the cross-sectional width 9 of the winding 2. Thereby, two longitudinal winding layers 2.8, 2.9 of winding 2 are stacked radially on the thread projection 6.1.

It should be noted that the asymmetric winding configuration shown in FIG. 6 (apparently more winding on upper half than on lower half) is merely due to the shown cross-section of the bobbin 1. After completing all turns of a single radial winding layer (for example, radial winding layer 2.1), the winding 2 is then transferred to a “next” radial winding layer (for example, radial winding layer 2.2), such that it appears in this cross-section that the winding is asymmetric.

In the present embodiment, two magnetic cores 31 are inserted into the bobbin 1. Commonly, an air gap 32 provided along the longitudinal axis 7 between the two magnetic cores 31 is provided so as to set an inductance value. As shown in FIG. 6, fringing magnetic fields 36 are generated at the air gap 32.

In the present embodiment, the threaded portion 6 is configured such that the winding 2 is at least partially moved away from the air gap 32 along the longitudinal axis 7. Thereby, the effect of fringing magnetic fields 36 on the winding 2 is reduced, which thus also reduces an AC resistance thereof. Furthermore, the manufacturing is simplified, since the winding 2 can be easily inserted into the threaded portion 6, especially via an automated winding process. Furthermore, a fill factor, i.e. a factor of winding-filled space to air-filled space of the bobbin 1, is kept high such that the cooling efficiency and overall size of the bobbin 1 are advantageously improved.

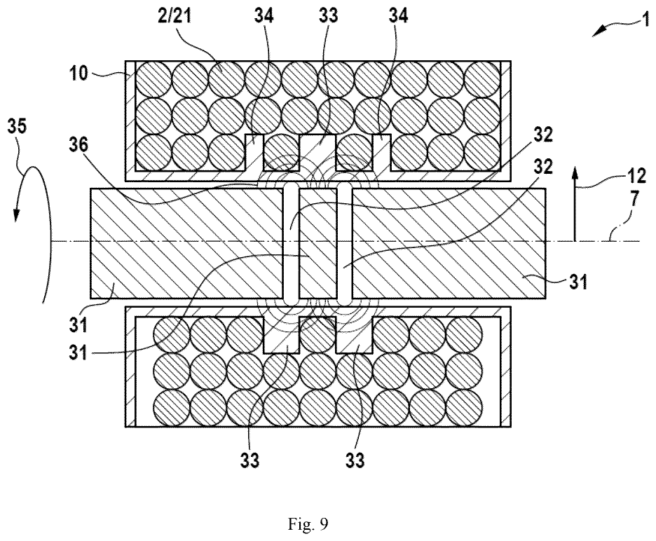

Now, with reference to FIGS. 7 to 9, a third embodiment of the present disclosure will be described. Therein, FIG. 7 shows a schematic side view of a bobbin 1 according to the third embodiment of the present disclosure, FIG. 8 shows a perspective view of the bobbin 1 according to the third embodiment of the present disclosure, and FIG. 9 shows a cross-sectional view of the bobbin 1 according to the third embodiment of the present disclosure.

In FIGS. 7 and 8, the winding 2 is omitted for ease of explanation of the base body 3, similar to parts of the foregoing described embodiments.

In the present embodiment, similar to the second embodiment the cross-sectional shape of the thread projections 6.1 varies along the spiraling extension of the threaded portion 6. In particular, the thread projections 6.1 are tapered towards their ends 14 along the longitudinal axis 7. Herein, the two non-threaded portions 13 each comprise roughly one-fourth of the length of the base body 3, whereas the threaded portion 6 comprises roughly one-half of the length of the base body 3 along the longitudinal axis 7.

As can be taken from FIG. 9, in the present embodiment, the bobbin 1 comprises three magnetic cores 31 with two air gaps 32 formed respectively between two adjacent magnetic cores 31 along the longitudinal axis 7.

Similar to the second embodiment, in the present embodiment, the AC resistance of the winding 2 is reduced by moving the winding 2 away from the fringing magnetic fields 36 at the air gaps 32. Therefore, as a comparison of FIG. 6 with FIG. 9 shows, the threaded portion 6 of the present embodiment is longer along the longitudinal axis 7. Further, by providing the winding 2 within the threaded portion 6, the fill factor is advantageously high, thus improving cooling and reducing the space required by the bobbin 1.

In some embodiments, the number of threaded portions 6 corresponds to the number of air gaps 32 formed between adjacent magnetic cores 31. In other words, if n air gaps 32 are provided, n threaded portions 6 are provided. In this regard, a single threaded portion 6 is defined as one continuous threaded portion 6. In particular, multiple threaded portions 6 are separated by non-threaded portions 13 therebetween.

Furthermore, in some embodiments, each of the threaded portions 6 is positioned radially outward from each of the air gaps 32. For example, if air gaps 32 are provided at ends 11 of the bobbin 1, the threaded portions 6 are also positioned at the ends 11 of the bobbin 1.

As opposed to for example providing a portion at the air gaps 32, around which strictly no winding 2 is wound, the present embodiment has the advantage in that a winding process is more efficient and can in particular be automated easily, especially since a continuous winding process can be employed.

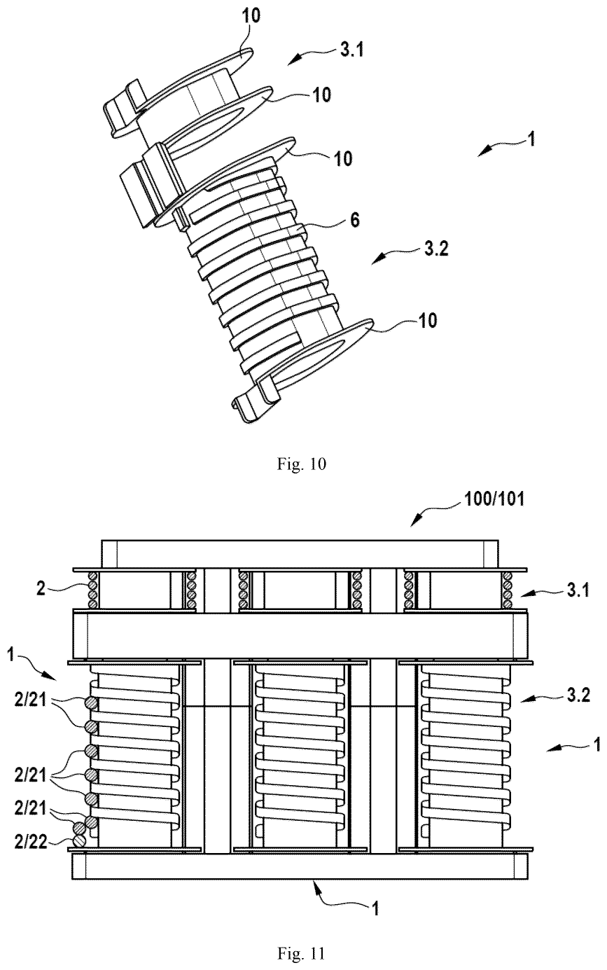

FIG. 10 shows a perspective view of a bobbin 1 according to a fourth embodiment of the present disclosure.

In the present embodiment, the bobbin 1 comprises multiple base bodies 3.1, 3.2, i.e. a first base body 3.1 and a second base body 3.2. Therein, the multiple base bodies 3.1, 3.2 are formed integrally with one another.

Herein, each of the base bodies 3.1, 3.2 comprises a winding (not shown). The windings of the base bodies 3.1, 3.2 may be separate, i.e. insulated, from one another, or may be connected to one another, in particular in series. For example, there is a case in which the winding wound around one base body 3.1 is a choke winding, and the winding wound around the other base body 3.2 is a primary or a secondary winding. In particular, in some embodiments, the winding of one base body 3.1 is connected in series with one winding portion of the other base body 3.2, for example the first winding portion 21 described above.

In addition, one or all of the multiple base bodies 3.1, 3.2 comprises the threaded portion 6.

FIG. 11 shows a schematic view of a magnetic component 100 according to a fifth embodiment of the present disclosure.

The magnetic component 100 of the present embodiment comprises three bobbins 1 according to any one of the foregoing embodiments. In particular, the magnetic component 100 as shown in FIG. 11 comprises three bobbins 1 according to the fourth embodiment, wherein each bobbin 1 comprises a first base body 3.1 and a second base body 3.2.

In the present embodiment, the magnetic component 100 comprises a three-phase transformer 101 formed via the winding 2 and the magnetic cores 31 (not visible in FIG. 11). Herein, the aforementioned first winding portion 21 of each bobbin 1 forms a primary winding of the transformer 101, and the aforementioned second winding portion 22 of each bobbin 1 forms a secondary winding of the transformer 101, with each bobbin 1 being a part of one phase of the three-phase transformer 101. The first base bodies 3.1 in the present example form chokes for the three-phase transformer 101. In some embodiments, the winding 2 of the base bodies 3.1 is respectively connected in series with the first winding portion 21 of each respective bobbin 1.

By the foregoing described embodiments, a bobbin 1 is achieved which is advantageously space-saving, while allowing easy and efficient manufacturing and cooling thereof. Furthermore, the foregoing described embodiments provide a magnetic component 100, particularly a transformer 101, with these advantages.

In addition to the foregoing written explanations, it is explicitly referred to FIGS. 1 to 11, wherein the figures in detail show configuration examples of the disclosure.

What is claimed is:

1. A bobbin for holding insulated winding, comprising:
a base body with an outer surface around which the winding is wound so as to define a winding axis; wherein
the outer surface comprises at least one threaded portion which spirals along a longitudinal axis of the base body, the threaded portion defining one or more thread projections and thread roots;
the winding comprises multiple radial winding layers stacked along a radial direction substantially perpendicular to the winding axis, and
at least one radial winding layer is inserted into the at least one threaded portion.

2. The bobbin according to claim 1, wherein exactly one longitudinal winding layer of the winding is inserted between two thread projections of the threaded portion.

3. The bobbin according to claim 2, wherein a thread pitch of the threaded portion is equal to or greater than a cross-sectional diameter of the winding and less than twice the cross-sectional diameter of the winding.

4. The bobbin according to claim 1, wherein the outer surface comprises exactly one continuous threaded portion.

5. The bobbin according to claim 1, wherein the thread root of the threaded portion is substantially flat or concave.

6. The bobbin according to claim 1, wherein the base body comprises at least one flange at respectively one end of the base body along the longitudinal axis of the base body.

7. The bobbin according to claim 1, wherein the outer surface of the base body comprises at least one non-threaded portion at respectively one end, along the longitudinal axis, of the threaded portion.

8. The bobbin according to claim 7, wherein at least two longitudinal winding layers of the winding are inserted into one non-threaded portion.

9. The bobbin according to claim 1, wherein at least one radial winding layer is stacked radially on at least one thread projection of the threaded portion.

10. The bobbin according to claim 1, wherein a thread pitch of the threaded portion is substantially constant along the longitudinal axis of the base body.

11. The bobbin according to claim 1, wherein a cross-sectional shape plane-parallel to the longitudinal axis of the thread projections is substantially constant along the spiraling extension of the threaded portion.

12. The bobbin according to claim 1, wherein a cross-sectional shape plane-parallel to the longitudinal axis of the thread projections varies along the spiraling extension of the threaded portion.

13. The bobbin according to claim 12, wherein the cross-sectional shape of the thread projections, along the spiraling extension of the threaded portion, is tapered towards at least one end of the thread projections.

14. The bobbin according to claim 1, wherein the winding comprises a first winding portion and a second winding portion which are electrically insulated from one another.

15. The bobbin according to claim 14, wherein only the radial winding layer(s) of the first winding portion of the winding is/are inserted into the threaded portion.

16. The bobbin according to claim 15, wherein only the radial winding layer(s) of the second winding portion of the winding is/are stacked radially on at least one thread projection of the threaded portion.

17. The bobbin according to claim 16, wherein the first winding portion and the second winding portion are at least partially in a bifilar arrangement.

18. The bobbin according to claim 17, wherein, in a first radial winding layer, the first winding portion is inserted into the threaded portion, and in at least one further radial winding layer, the first winding portion and the second winding portion are arranged in bifilar arrangement such that the second winding portion is stacked radially on the thread projections and the first winding portion is stacked radially on the first winding portion of the first radial winding layer.

19. A magnetic component, comprising at least one bobbin according to claim 1.

20. The magnetic component according to claim 19, wherein the winding comprises a first winding portion and a second winding portion which are electrically insulated from one another;
wherein the magnetic component comprises a transformer and the first winding portion is part of a primary winding and the second winding portion is part of a secondary winding of the transformer.
